(19) United States
(12) Patent Application Publication
(10) Pub. No.: US 2018/0294851 A1
(43) Pub. Date: Oct. 11, 2018

(54) Method for Efficient and Cost Effective Orthogonal Angular Beamforming

(71) Applicant: Carl Cao, San Jose, CA (US)

(72) Inventor: Carl Cao, San Jose, CA (US)

(21) Appl. No.: 15/690,221

(22) Filed: Aug. 29, 2017

Related U.S. Application Data
(60) Provisional application No. 62/484,015, filed on Apr. 11, 2017.

(51) Int. Cl. H04B 7/0452; H04B 7/06; H04L 25/03

(52) U.S. Cl. CPC H04B 7/0452; H04L 25/0391; H04B 7/0617

(57) ABSTRACT

The present invention disclosure relates to methods to construct an efficient and low-cost massive MU-MIMO system for wireless communications. It enables beamforming in the angular domain. It consists of several components. The first component is a method to construct two orthogonal one-dimensional component reference ULAs of an UPA. Hence the channel vector of the RF signals, in the angular space, from each UE over the entire UPA of the BS can be constructed from channel estimation for each component ULA, which reduces the number of receive signal chains from M×N to M+N and thus reduces the cost of the BS equipment. The second component is a method to schedule UEs for transmission in the downlink from available UEs that have a channel vector. The scheduled UEs result in a channel matrix with a simple solution, constructed in the angular space, for inversion of a large correlation matrix so as to enable efficient beamforming to these UEs and to ensure that inter-user interference is eliminated. The third component is a method to optimize the trade-off between the number of UEs scheduled and the signal diversity of each UE to ensure the quality of the signal beams to that UE.

### RELATED APPLICATIONS

This application claims the priority benefit of U.S. Provisional Application No. 62/484,015, filed on Apr. 11, 2017, the disclosure of which is incorporated herein by reference in its entirety.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### TECHNOLOGY FIELD

This invention concerns a method to provide low-cost and efficient beamforming, in the angular space, of a massive MU-MIMO system for wireless communications.

### BACKGROUND

A major part of the 5^{th} Generation (5G) mobile wireless technology is enhanced Mobile Broadband (EMBB). While its parameters are still being discussed in 3GPP, e.g., the frequency band, modulation, etc., the basic shape is in place. 5G EMBB aims to support multi-GBPS throughput in each cell: a significant advancement over existing LTE, or LTE-Advanced+ technologies. A key enabler to achieve this goal is the use of massive Multi-User (MU) MIMO (Multiple-In Multiple-Out), where the base station (BS) employs a large antenna array with hundreds or more antenna elements 100 as shown in FIG. 1. Usually arranged in a single row or two-dimensional plane with antenna elements spaced critically, i.e., in distance half of the wavelength of the wireless carrier frequency, the set of antennas in the plane are called Uniform Planar Array (UPA).

Let the number of antenna elements be M and the number of single-antenna User Equipment (UE) served by each cell be K. In MU-MIMO, the BS transmits data to each UE in a non-cooperative manner (i.e., each UE has no mutual knowledge of each other's wireless channel). The BS produces a beam with the phases of signals from different antenna elements precisely controlled so that they constructively add in the path toward the target UE. At the same time, they cancel out each other destructively in other directions. The basic idea is that beam directions, or “angles”, orthogonalize the signals towards different UEs so there is no, or little, interference between users.

The number of antennas of the UPA (M=M_{H}×M_{V}) determines the resolution of the beam, i.e., M_{H} angles in the horizontal dimension and M_{V} angles in the vertical dimension. So with larger M_{H} and M_{V}, i.e., larger aperture, each beam becomes narrower and the separation between beams becomes sharper. With M≥K, at least K beams can be formed. When M>>K and M→+∞, for sufficiently large α=M/K, e.g., α≥10, a condition called “favorable propagation” prevails such that the UPA can form orthogonal beams to each UE, i.e., the beans are separated and inter-user interference vanishes.

The BS contains a number of downlink (BS-to-UE) and uplink (UE-to-BS) signal processing chains. An example of the processing chains 200 is shown in FIG. 2.

In order to form beams, the Channel State Information (CSI) from the UPA to the UE is needed by the BS, i.e., through the channel estimation step 201 as in FIG. 2, from the transmission of reference signals in the uplink direction. This is particularly convenient in the case of a Time Division Duplexing (TDD) wireless system, where the CSI is reciprocal between the uplink and the downlink directions. The beamforming coefficients can be computed from the CSI, which is usually organized in a M×K channel matrix of complex numbers for uplink and K×M channel matrix for the downlink for M antenna elements and K users.

The beamforming coefficients for the uplink beams, i.e., the BS as the receiver, can be written as a K×M matrix. The beamforming coefficients for downlink beams, i.e., the BS as the transmitter, can be written as a M×K matrix, similarly.

A crucial step in computing the beamforming coefficients involves inverting the correlation matrix of the channel matrix. This is computationally demanding, with a large matrix, and is not suitable for being parallelized either because of the structure of the matrix inversion procedure. Additionally, for receiving and transmitting real-time signals such computation must be completed within a stringent time budget.

Matrix inversion is a major technical problem and hence a solution that can minimize this problem will be very useful. This can be done by using specific processing techniques to intelligently schedule the UEs so that their signal paths are orthogonal in the angular space when transmitted by the BS in the downlink after we “snap” the signal space into an angular “grid” system using 2D Discrete Fourier Transforms from the planar antenna space.

Another problem is that each antenna in the UPA needs to be supported by a full chain of baseband, digital radio, and analog radio processing components. For a large M, the cost of the hardware equipment is high. For a wireless communications system, the cost becomes prohibitive, as it is multiplied by the number of cell sites that require at least one such UPA.

Usually the uplink processing chain is much more complex, notably the LNA 203, ADC 202, and digital signal processing steps in FIG. 2, and is more costly. Hence a solution to minimize the overall processing chains, and in particular, the uplink is sought. This can be achieved with the use of specialized processing techniques, by which the full CSI can be extrapolated from much fewer uplink chains, when reference signals are transformed into the angular domain.

### SUMMARY

This invention disclosure presents a method for efficient and cost effective angular beamforming in a massive MU-MIMO system. Reduced cost of hardware equipment is achieved by decomposing the two-dimensional UPA into two linear, orthogonal ULAs. The channel matrix for the UPA can be constructed from the ULAs, with degree-of-magnitude reduction in the number of processing chains. Users are scheduled to form beams, in the angular space, that avoid inter-user interference and enhance beam diversity. This scheduling, which staggers the users in the time domain, causes the correlation matrix to be, component wise, block diagonal. As long as the blocks have small sizes, the overall matrix has simple solutions for matrix inversion, even if the matrix size is large.

### BRIEF DESCRIPTION OF THE DRAWINGS

FIG. 1 is an example UPA in a massive MU-MIMO system with M, or M_{H}×M_{V}, elements where antenna elements are placed in critical separation.

FIG. 2 depicts the most critical parts of downlink and uplink analog (RF) and digital signal processing chains, respectively, of a massive MU-MIMO system.

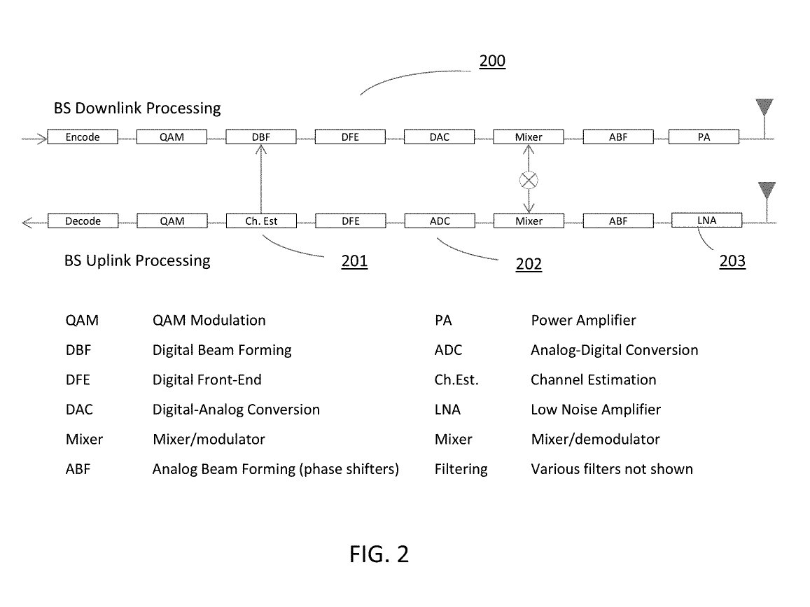

FIG. 3 shows a tilted UPA, e.g., deployed on a cellular radio mast, and a signal path that impinges upon the elements of the UPA with a certain azimuth and elevation.

FIG. 4 illustrates signal paths from a specific UE antenna through one or more scatterers and the signals that then impinge on the UPA.

FIG. 5 gives a picture of two component reference ULAs of a UPA, intersecting at the reference antenna element that is located at the center of the UPA, i.e., with a position index of (0, 0).

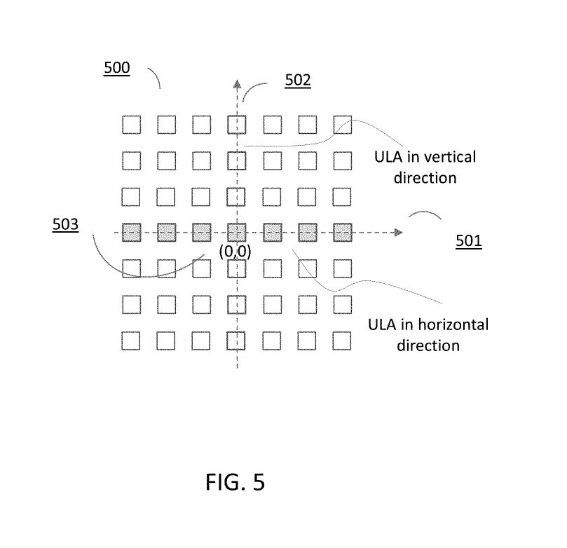

### DETAILED DESCRIPTION

We model the uplink, narrow-band Gaussian [symbol] (0, δ²) i.i.d, channel vector Hₖ in the antenna space domain for the kth UE as:

$${h}_{k , mn} = \frac{1}{\sqrt{UV}} {\sum }_{u = 1}^{U} {\sum }_{v = 1}^{V} ( {g}_{k} ( {φ}_{k , u} , {θ}_{k , v} ) \cdot {f}_{mn} ( {φ}_{k , u} , {θ}_{k , v} ) for k = 1 , … , K . \qquad Eqn ( 1 )$$

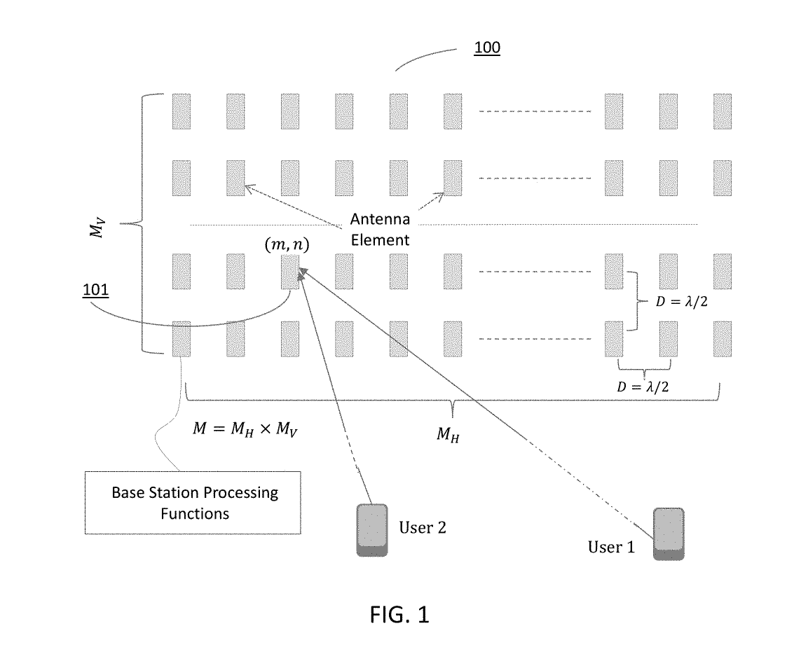

of the (m, n) element 101, where the base station (BS) is equipped with a UPA 100 as in FIG. 1, consisting of M_{H} antenna elements in each row, and M_{V} elements in each column, M=M_{H}×M_{V}.

Each element of the UPA is indexed by (m, n) and

$${M}_{-} = - \frac{( {M}_{V} - 1 )}{2} \leq m \leq {M}_{+} = \frac{( {M}_{V} - 1 )}{2} and$$

$${N}_{-} = - \frac{( {M}_{H} - 1 )}{2} \leq n \leq {N}_{+} = \frac{( {M}_{H} - 1 )}{2} ,$$

with the center element m=0 and n=0.

Each row of the UPA also forms a Uniform Linear Array (ULA) of M_{H} elements, e.g., the middle (or zero) row and each column also forms a (vertically oriented) ULA of M_{V} elements.

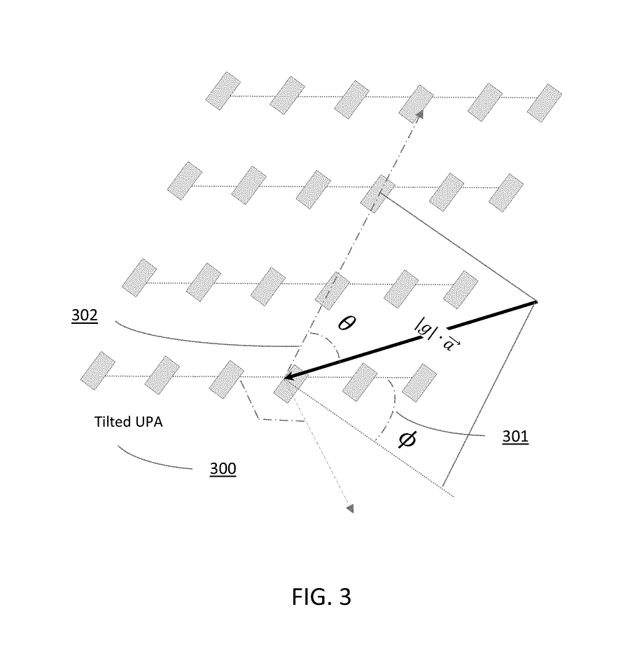

ϕ(0≤A₋≤ϕ<A₊<π) is the azimuth of a signal path 301 as shown in FIG. 3, in which a signal impinges upon, or from which the signal leaves, the UPA, θ (0≤E₋≤θ<E₊<π) 302 is the elevation.

As it is often the case, the UPA is tilted in the direction of the targeted concentration of users 300 as in FIG. 3. Usually, for example, (A₊−A₋<2π/3), and (E₊−E₋<π/2), and often (E₊−E₋<<π/2), with orientation towards the ground level.

The angle of the signal paths is indexed, in the angular space, by a maximum of U such that A₋≤ϕ_{k,0}, ϕ_{k,U}<A₊, and a maximum of V such that E₋≤θ_{k,0}, θ_{k,V}<E₊.

gₖ(ϕ, θ) is the complex gain of the signal path (ϕ, θ), in the angular space, from the UE to the UPA.

fₘₙ(ϕ, θ) is the response vector of the (m, n) element of the signal path (ϕ, θ) in the uplink. When it is expanded in detail,

fₘₙ(ϕ,θ)=exp(j2π·n·Ω(ϕ,θ)·exp(j2π·m·Ψ(Ψ)),

where Ω(ϕ, θ)=D_{H}·cos(ϕ)sin(θ) and in [−D_{H}, D_{H}) for A₋≤ϕ<A₊ and E₋≤θ<E₊, and Ψ(θ)=D_{V}·cos(θ) and in [−D_{V}, D_{V}) for E₋≤θ<E₊, D is the normalized distance, to the wave-length λ of the signal carrier frequency, between elements of the UPA. Without loss of generality, we assume D=D_{V}=D_{H}=½λ.

fₘₙ(ϕ, θ) is the steering vector of the (m, n) element of the signal path (ϕ, θ) in the downlink. It is noted that in TDD wireless systems the steering vector is from the UPA to the UE, and the response vector is from the UE to the UPA, of the reciprocal signal path.

The M×1 (column) channel vector Hₖ of user k in the uplink is:

[E(h_{k,M}_{_{−}}_{N}_{_{−}}),E(h_{k,M}_{_{−}}_{(N}_{_{−}}₊₁₎), . . . ,E(h_{k,M}_{_{−}}₀), . . . ,E(h_{k,M}_{_{−}}_{(N}_{₊}₋₁₎),E(h_{k,M}_{_{−}}_{N}_{₊}), . . . ,E(h_{k,0N}_{_{−}}),E(h_{k,0(N}_{_{−}}₊₁₎), . . . ,E(h_{k,00}), . . . ,E(h_{k,0(N}_{₊}₋₁₎),E(h_{k,0N}_{₊}), . . . ,E(h_{k,M}_{₊}_{N}_{_{−}}),E(h_{k,M}_{₊}_{(N}_{_{−}}₊₁₎), . . . ,E(h_{k,M}_{₊}₀), . . . ,E(h_{k,M}_{₊}_{(N}_{₊}₋₁₎),E(h_{k,M}_{₊}_{N}_{₊}),]^{T} Eqn (2)

where each element in Eqn (2) is averaged across multiple narrow-band channels or subcarriers of the user.

We perform quantization on (ϕ, θ) and Ψ(θ) such that

$${—}_{—} Ω ( φ , θ ) \text{:} [ {U}_{-} Δ w , … , - u Δ w , … , 0 , … , u Δ w , … , {U}_{+} Δ w ] , \\ for {U}_{-} \leq u \leq {U}_{+} , Δ w + D \frac{2}{{s}_{H} \cdot {M}_{H}} = \frac{1}{{s}_{H} \cdot λ} , \\ \overline{—} Ψ ( θ ) \text{:} [ {V}_{-} Δ γ , … , - v Δ γ , … , 0 , … , v Δ γ , … , {V}_{+} Δ γ ] , \\ for {V}_{-} \leq v \leq {V}_{+} , Δ γ = D \frac{2}{{s}_{V} \cdot {M}_{V}} = \frac{1}{{s}_{V} \cdot λ} ,$$

where s_{H} ∈ [symbol] and s_{V} ∈ [symbol] are integer scaling factors and

$${U}_{-} = - \frac{( {M}_{H} - 1 )}{2} , {U}_{+} = \frac{( {M}_{H} - 1 )}{2} , \\ {V}_{\_} = - \frac{( {M}_{V} - 1 )}{2} , {V}_{+} = \frac{( {M}_{V} - 1 )}{2} .$$

Without the loss of generality we will use s_{H}=s_{V}=1 for the rest of the document, unless explicitly stated otherwise.

Hence, fₘₙ(ϕ, θ) can be rewritten as:

\ddot{f}ₘₙ(u,v)e^{j2πn·u·Δw}e^{j2πm·v·Δγ}, Eqn (3)

where: θ=cos⁻¹(vΔγ/D), θ has a unique solution for E₋≤θ<E₊, ϕ=cos⁻¹(uΔw/D sin(θ)), ϕ has a unique solution for A₋≤ϕ<A₊, given θ.

Sorting each (ϕ, θ) signal path in Eqn (1) into “bins” in the quantized coordinates of Ω(ϕ, θ) and Ψ(θ), the channel can be approximated by:

$$\begin{matrix}{h}_{k , mn} \approx {\ddot{h}}_{k , mn} \\ = \frac{1}{\sqrt{{M}_{H} {M}_{V}}} {\sum }_{u = {U}_{-}}^{{U}_{+}} {\sum }_{v = {V}_{-}}^{{V}_{+}} ( {\ddot{g}}_{k , uv} \cdot {\ddot{f}}_{mn} ( u , v ) ) \\ = \frac{1}{\sqrt{M}} {\sum }_{u = {U}_{-}}^{{U}_{+}} {\sum }_{{V}_{-}}^{{V}_{+}} ( {\ddot{g}}_{k , uv} \cdot {e}^{j 2 π n \cdot u \cdot Δ w} {e}^{j 2 π m \cdot v \cdot Δ γ} ) ,\end{matrix} \qquad Eqn ( 4 )$$

where: g_{k,uv}, (also written as gₖ(u, v)), is the complex gain gₖ(ϕ_{k,u}, θ_{k,v}) after changing variables. This value may be 0 for a particular discrete signal path (u, v). Adjacent “bins” may be clustered together to form a “larger” (ϕ, θ) path, e.g., for non-zero valued gₖ(u, v), gₖ(u+1, v), gₖ(u, v+1), gₖ(u+1, v+1), and so forth in a contiguous group.

The quantization of the signal path in the domain of (u, v) is uniform (but it is not uniform in the domain of (ϕ, θ)), with a translation of θ=cos⁻¹(vΔγ/D), and ϕ=cos⁻¹(uΔw/D sin(θ)). However, the adjacency of two indices (u₁, v₁) and (u₂, v₂) is maintained between the two domains and proportional to the values of M_{H}, M_{V}.

It is clear that h_{k,mn} is the 2D Inverse Discrete Fourier Transform of g_{k,uv}, and g_{k,uv} is the 2D Discrete Fourier Transform of h_{k,mn}. Hence we can write:

$$\begin{matrix}{\ddot{g}}_{k , uv} = \frac{1}{\sqrt{{M}_{H} {M}_{V}}} {\sum }_{m = {M}_{-}}^{{M}_{+}} {\sum }_{n = {N}_{-}}^{{N}_{+}} ( {h}_{k , mn} \cdot {e}^{- j 2 π u \cdot n \cdot Δ w} {e}^{- j 2 π v \cdot m \cdot Δ γ} ) \\ = \frac{1}{\sqrt{M}} {\sum }_{m = {M}_{-}}^{{M}_{+}} {\sum }_{n = {N}_{-}}^{{N}_{+}} ( {h}_{k , mn} \cdot {f}_{uv}^{*} ( m , n ) )\end{matrix} \qquad Eqn ( 5 )$$

Note the argument fᵤᵥ*(m, n) is the complex conjugate of \ddot{f}ₘₙ(u, v).

This relationship can be understood that fᵤᵥ*(m, n) is sampling from the antenna space and transforming the samples into the angular space while \ddot{f}ₘₙ(u, v) is sampling from the angular space to the antenna space, which is the dual of each other. Note also fᵤᵥ*(m, n) needs not be approximate such as \ddot{f}ₘₙ(u, v) as it stems directly from the UPA architecture with spacing of antenna elements at D. In the following we will drop the “\ddot{}” sign on symbols, and disregard this approximation.

Given that M_{H} and M_{V} have small, finite dimensions. For example, 16×16 UPA can support an antenna array of 256 elements, 32×32 can support 1,024 elements. gₖ(u, v) in Eqn (5) can be computed efficiently using 2D DFT (or if M_{H} and M_{V} are to the power of 2, more efficient 2D FFT may be applied).

From Eqn (5), the narrow-band channel h_{k,mn}, for the kth user, and (m, n) antenna element, in the antenna space is transformed into the (discretized) angular space. The values of h_{k,mn} need to be known; they are obtained through channel estimation, which has established methods in the wireless industry, e.g., for 3GPP LTE. For this document, it is assumed that h_{k,mn} is available, i.e., the channel matrix is known.

In general, the channel matrix in the downlink can be obtained by the UE. The mth antenna element (m≤M) transmits reference signals to the UEs. The kth UE (k≤K) performs channel estimation and then feedback the kth (row) channel vector to the BS for a total of K vectors.

In the case of TDD, the kth UE (k≤K) transmits reference signals to the BS such that they are received at the UPA by each (m, n) element to obtain h_{k,mn}. Since the channel is reciprocal, the k→(m, n) channel is the same for (m, n)→k. If the uplink channel matrix for K users is H=[H₁, H₂, . . . , Hₖ . . . , H_{K}], the downlink channel matrix is then H^{T}, a simple transpose of the uplink matrix.

In the downlink, for a K×1 signal vector X, to be transmitted to the K independent UE, the received signals at the UEs can be expressed as a K×1 (column) vector Y:

Y=H^{T}·W·X+N,

where: H^{T} is the K×M channel matrix: [H₁, H₂, . . . , H_{K}]^{T} as in Eqn (2), W is a M×K beamforming coefficient matrix of complex weights for massive MU-MIMO beamforming, N is the [symbol] (0, δ_{N}²), complex Gaussian K×1 noise vector.

W is constructed such that, without loss of generality, with reference to Zero-Forcing beamforming:

Y=H^{T}·W·X+N=H^{T}(H^{T})^{†}X+N=X+N,

so that X can be recovered by each user, cancelling out the interference from other users (given the residual noise). In Zero-Forcing beamforming:

W=(H^{T})^{†}=(H^{T})*(H^{T}·(H^{T})*)⁻¹, Eqn (6)

where (H^{T})^{†} is the pseudo-inverse of the correlation matrix H^{T}·(H^{T})* and (H^{T})* is the conjugate transpose of the channel matrix H^{T}. Given that H is known, W can be computed and hence the beamforming problem can be solved with sufficient computing power.

(H^{T}·(H^{T})*)⁻¹ gives rise to a matrix inversion of K×K matrix. Given that W needs to be updated within specific time constraint (i.e., the wireless channel coherence time), it is often impractical to perform this inversion within the required timing budget, as K is large.

A similar problem exists for the uplink. In this case, the beamforming coefficient matrix needs to be computed from inverting a M×M correlation matrix. As >>K, the problem can in fact be more severe.

Following Eqn (4), in a more compact matrix form: H=F·G, is the M×K channel matrix from K users to the M elements of the UPA, where: G=[G₁, . . . , Gₖ, . . . , G_{K}] is a M×K matrix, for the quantized M signal angles of each of the K UEs. For the kth UE,

Gₖ=[g_{k,U}_{_{−}}_{V}_{_{−}},g_{k,U}_{_{−}}_{(V}_{_{−}}₊₁₎, . . . ,g_{k,U}_{_{−}}₀, . . . ,g_{k,U}_{_{−}}_{(V}_{₊}₋₁₎,g_{k,U}_{_{−}}_{V}_{₊}, . . . ,g_{k,0V}_{_{−}},g_{k,0(V}_{_{−}}₊₁₎, . . . ,g_{k,00}, . . . ,g_{k,0(V}_{₊}₋₁₎,g_{k,0V}_{₊}, . . . ,g_{k,U}_{₊}_{V}_{_{−}},g_{k,U}_{₊}_{(V}_{_{−}}₊₁₎, . . . ,g_{k,U}_{₊}₀, . . . ,g_{k,U}_{₊}_{(V}_{₊}₋₁₎,g_{k,U}_{₊}_{V}_{₊}]^{T} Eqn (7)

F=[F_{M}_{_{−}}, F_{(M}_{_{−}}₊₁₎, . . . , F₋₁,1, F₁, . . . , F_{(M}_{₊}₋₁₎, F_{M+}] is a M×M matrix, for M antenna elements and M signal paths.

$${F}_{i} = \frac{1}{\sqrt{M}} ( {F}_{H , i} ⊗ {F}_{V , i} )$$

is the M×1 steering vector of the ith signal angle, where “⊗” is the Kronecker product of two matrices:

$${F}_{H , i} = [ \begin{matrix}exp ( j 2 π \cdot {N}_{-} \cdot i Δ w ) \\ exp ( j 2 π \cdot ( {N}_{-} + 1 ) \cdot i Δ w ) \\ ⋮ \\ exp ( j 2 π \cdot ( - 1 ) \cdot i Δ w ) \\ 1 \\ exp ( j 2 π \cdot 1 \cdot i Δ w ) \\ ⋮ \\ exp ( j 2 π \cdot ( {N}_{+} - 1 ) \cdot i Δ w ) \\ exp ( - j 2 π \cdot {N}_{+} \cdot i Δ w )\end{matrix} ]$$

$${F}_{V , i} = [ \begin{matrix}exp ( j 2 π \cdot {M}_{-} \cdot i Δ γ ) \\ exp ( j 2 π \cdot ( {M}_{-} + 1 ) \cdot i Δ γ ) \\ ⋮ \\ exp ( j 2 π \cdot ( - 1 ) \cdot i Δ γ ) \\ 1 \\ exp ( j 2 π \cdot 1 \cdot i Δ γ ) \\ ⋮ \\ exp ( j 2 π \cdot ( {M}_{+} - 1 ) \cdot i Δγ ) \\ exp ( j 2 π \cdot {M}_{+} \cdot i Δ γ )\end{matrix} ]$$

It is clear that F is a unitary matrix (and Hermitian), i.e., F·F*=I, where I is the M×M identity matrix. Hence, F*H=F*FG, and:

G=F*·H. Eqn (8)

By inspection of Eqn (7), Gₖ vector fully captures all the information required of a UE's signal paths (with the approximation permitted by the scale of quantization). For any given Gₖ_{₁} and Gₖ_{₂}, if gₖ_{₁}_{,uv} and gₖ_{₂}_{,uv} are both non-zero, there is inter-user interference in the BS to UE transmission. Hence, it is necessary to schedule UE strategically to exclude interferers. We perform the series of operations to achieve this goal: Prioritization, Discard, Filtering, Nulling, Clustering, Compacting, and Splitting.

Prioritization:

The norm ∥Gₖ∥ captures the total gain of the signal paths for UE k. Higher ∥Gₖ∥ potentially leads to better signal quality of a single signal path. Alternatively, there are more signal paths to the same UE that leads to better diversity so that the signal is more robust. ∥Gₖ∥ is used as a measure of the signal quality. So, the scheduling of such a UE is preferred for higher ∥Gₖ∥.

Discard:

UE with a low ∥Gₖ∥ is removed from the available UEs for scheduling.

Filtering:

An element g_{k,uv} of Gₖ is filtered by the function ρ(∥Gₖ∥, ∥g_{k,uv}∥). g_{k,uv} is removed from Gₖ, i.e., it contributes insignificant amount to the signal quality. The result, thus obtained \tilde{G}ₖ, can be set by a Threshold_{F} either as an absolute value or as a ratio between the values.

Nulling:

if gₖ_{₁}_{,uv} and, gₖ_{₂}_{,uv} are interfering with each other. User k₁ is prioritized by nulling out the gain gₖ_{₂}_{,uv} by evaluating the function σ(∥\tilde{G}ₖ_{₂}∥, ∥gₖ_{₂}_{,uv}∥). The result can be set by a Threshold_{N} either as an absolute value or as a ratio between the values.

Clustering:

For any given \tilde{G}ₖ, adjacent elements in (u, v), e.g., \tilde{g}_{k,(u-1)(v-1)}, \tilde{g}_{k,(u-1)v}, g_{k,u(v-1)} etc. form a cluster \tilde{G}ₖ^{c}, (c=0, 1, . . . , C) of “subbeams”. A larger cluster, consisting of adjacent signal “angles”, represents intra-path diversity. It is preferable to cluster them into a single beam, adding these components until ∥gₖ_{₂}_{,uv}∥ exceeds Threshold_{C}; this overcomes the weakness of each signal angle on its own. The composite path produces a higher path gain Σ_{i,j}∥g_{k,u}_{ᵢ}ᵥ_{ⱼ}∥.

Compacting:

The cluster size has a major impact on the computational complexity, i.e., the component matrix to invert, so that the cluster size is controlled within a small limit l. When l is exceeded, the cluster size is reduced by either breaking up the cluster into two balanced clusters with ∥\tilde{G}ₖ^{c1}∥ and ∥\tilde{G}ₖ^{c2}∥, or additional small gain elements may be nulled.

Splitting:

Clustering creates ordered clusters so that each ∥\tilde{G}ₖ^{c}∥>Threshold_{C}. These clusters provide inter-path diversity. For the given clusters \tilde{G}ₖ^{c} of \tilde{G}ₖ, separate gain vectors \tilde{G}ₖ¹, . . . , \tilde{G}ₖ^{b} . . . , \tilde{G}ₖ^{B} (B≤C), ranked by the norms of each cluster in descending order and filtered by its norm (so the low norm vectors are discarded), are produced such that each \tilde{G}ₖ^{b} may be viewed as a separate virtual user.

A fairness criterion is applied to the final set \tilde{G}′ of UEs. The signal quality of some UEs is enhanced at the expense of other UEs so that a richer intra-path and inter-path diversity is maintained for these UEs. For example, for an UE that has not gained the opportunity to transmit for an extended period of time.

After processing Gₖ in these steps iteratively, the matrix \tilde{G}′=[\tilde{G}₁′, \tilde{G}₂′, . . . , \tilde{G}_{K}′] represents R=(K−O) actual users that are scheduled for transmission by the UPA, where O is the number of virtual users created in this process. This trades off the number of users supported, while increasing the diversity for particular users.

There exist a L and P, such that \tilde{G}′ can be expressed as:

\tilde{G}′=L·D·P, Eqn (9)

where D is a M×K matrix, L is a M×M row permutation matrix, and P is a K×K column permutation matrix. D has the property that (i) on each row, there is a single nonzero value, (ii) there are exactly M non-zero values, and (iii) on each column, the nonzero values are in one contiguous sequence of size ≤l.

Following Eqn (6):

$$\begin{matrix}W = {( {H}^{T} )}^{*} {( {H}^{T} \cdot {( {H}^{T} )}^{*} )}^{- 1} \\ = {( {( F \cdot {\tilde{G}}^{′} )}^{T} )}^{*} {( {( F \cdot {\tilde{G}}^{′} )}^{T} \cdot {( {( F \cdot {\tilde{G}}^{′} )}^{T} )}^{*} )}^{- 1} \\ = {F}^{*} {L ( {D}^{T} )}^{*} P \cdot {( {P}^{T} {{D}^{T} ( {D}^{T} )}^{*} P )}^{- 1} \\ = {F}^{*} {L ( {D}^{T} )}^{*} P \cdot {Q}^{- 1}\end{matrix} \qquad Eqn ( 10 )$$

Note that the inverse of the matrix Q=P⁻¹D^{T}(D^{T})*P is easily computed, where

Q⁻¹=(P⁻¹·D^{T}·(D^{T})*·P)⁻¹=P·(D^{T}·(D^{T})*)⁻¹·P⁻¹=P·(D^{T}·(D^{T})*)⁻¹·P^{T}.

It is obvious that D·D* is a block diagonal matrix. It has simple inversion solutions when the block size is small (l≤4), which is the result of clustering and additional filtering/nulling operations. We therefore have successfully reduced the problem of inverting a large square matrix into a number of very small matrices.

Finally observing the composition of W, we notice that L(D^{T})*P·Q⁻¹ is the digital part of the coding matrix. It constructs the orthogonal angular beams for K virtual (or R real) users. F* is a phase rotation component, with unity gain; it can be implemented either digitally or by (analog) phase shifters for the M antenna elements.

The full matrix W, from Eqn (6), can be computed from Hₖ. However, it requires that there be a full processing chain supporting each (m, n) element in the UPA, which includes RF, digital radio, and baseband processing steps. In a massive MU-MIMO system, to ensure beamforming quality (i.e., to achieve “favorable propagation”), M>>K. A high M means that the cost in hardware for supporting full beamforming is high.

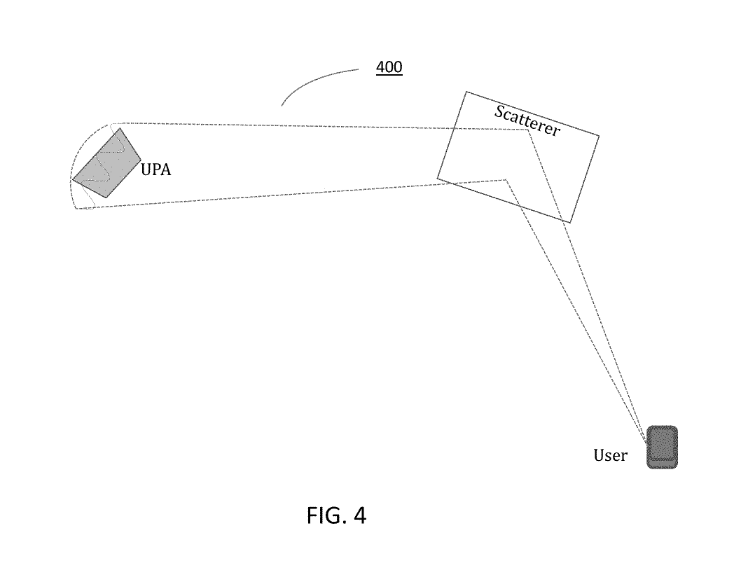

Fortunately, we can exploits the structure of the UPA and minimize the amount of hardware necessary for acquiring Hₖ. We assume

$$d ≫ \frac{λ}{2} M > \frac{λ}{2} max ( {M}_{H} , {M}_{V} ) ,$$

where d is the distance of any user to the UPA. Thus, a signal path impinging upon the UPA 400 in the far field as in FIG. 4 will arrive at all M antenna elements as a plane wave in the direction of propagation.

As a result, individual signal path will have approximately the same gain: g_{k,uv}, for all elements. It will impinge upon different antenna elements with different phases, due to the geometry of the antenna elements. (h_{k,mn} will be different after summing up different signal paths with different phase rotations.) Furthermore, the gains in horizontal and vertical dimensions are independent, with reference to the antenna elements (0, n), N₋≤n≤N₊, of the zeroth row and (m, 0), M₋≤n≤M₊, of the zeroth column:

g_{k,uv}=Λ̅(gₖ(0,v)/cos θ,gₖ(u,0)/sin ϕ) Eqn (11)

where Λ̅(⋅, ⋅) is the geometric mean function, θ is the elevation, and ϕ is the azimuth angle of g_{k,uv} element in the angular space.

g_{k,uv} can be obtained from a reference antenna element (e.g., (0,0), of the UPA). gₖ(u, 0), U₋≤u≤U₊, is the horizontal component of the gain of a signal path from the kth user to the ULA formed by the zeroth row of the UPA. gₖ(0, v), V₋≤v≤V₊, is the vertical component of the gain of a signal path from the kth user to the ULA formed by the zeroth column of the UPA.

Now consider:

$${g}_{k} ( u , 0 ) = \frac{1}{{M}_{H}} {\sum }_{n = {N}_{-}}^{{N}_{+}} ( {h}_{k } ( 0 , n ) \cdot {e}^{- j 2 π \cdot u \cdot n \cdot Δ w} ) ,$$

and similarly:

$${g}_{k} ( 0 , v ) == \frac{1}{{M}_{V}} {\sum }_{m = {M}_{-}}^{{M}_{+}} ( {h}_{k } ( m , 0 ) \cdot {e}^{- j 2 π \cdot v \cdot m \cdot Δ γ} ) .$$

As in Eqn (11), Gₖ can be produced from the values of g_{k,uv} and then Hₖ=F·Gₖ. This results in the M×K matrix G as in Eqn (7). Subsequently, the full channel matrix can be computed: H=F·G.

From these steps, the number of uplink baseband, digital radio, and RF processing chains has been reduced to (M_{H}+M_{V}) from M. In general, the uplink receiver chains are much more expensive. First, the receiver digital components, including the digital front-end, channel estimation, etc. are much more complex than their counter-parts for transmission. This means that the system employing this method to reduce the number of receiver chains used for channel estimation has lower overall cost.

A concern regarding the quantization of the angular space of a UPA is that it may provide insufficient resolution, as real world user signal paths are (close to) continuous and they do not snap into neat “grids” on a globe. In our quantization, it is performed over the (Ω(ϕ, θ), Ψ(θ)) space, not (ϕ, θ) directly. It is well-known that Discrete Fourier Transform causes leakage when the signal paths do not align with the center of the analytical “frequencies” (or in this case, angles) of quantization.

The resolution of the UPA angular beams is determined by the parameters of M_{H}, M_{V}. Increasing these parameters will cause the increase in the number of antenna elements, which leads to the increased cost of equipment that we sought to reduce. An alternative is to zero-pad the Discrete Fourier Transform of our spatial samples from M_{H}, M_{V}, and use quantization factors (s_{H}·M_{H}), (s_{V}·M_{V}), where (s_{H}, s_{V}) are integer scalars for the Fourier Transform. Following Eqn (8)

$${G}_{{s}_{H} \cdot {M}_{H} , {s}_{V} \cdot {M}_{V}} = {F}_{( {s}_{H} \cdot {M}_{H} ) , ( {s}_{V} \cdot {M}_{V} )}^{*} ( \begin{matrix}H \\ 0 \\ … \\ 0\end{matrix} ) .$$

The resulting Gₛ_{_{H}}_{·M}_{_{H}}_{,s}_{_{V}}_{·M}_{_{V}} is a matrix expanded by s_{H} times in the Ω(ϕ, θ) dimension and s_{V} times in the Ω(θ) dimension. We can then determine the angular beams in G_{M}_{_{H}}_{,M}_{_{V}}.

The first, simple, method would be to average over s_{H}, s_{V} samples of Gₛ_{_{H}}_{·M}_{_{H}}_{,s}_{_{V}}_{·M}_{_{V}} to obtain G_{M}_{_{H}}_{,M}_{_{V}} and simply selecting the middle item of the s_{H}, s_{V} samples for beamforming.

The second method would be to select the strongest sample of s_{H}, s_{V} samples. In this case, since the selected item will not necessarily have the same aligned index in G_{M}_{_{H}}_{,M}_{_{V}}, it would be necessary to rotate the beam from F_{M}_{_{H}}_{,M}_{_{V}}. The resulting channel matrix will look like:

$$\check{H} = {[ \begin{matrix}D ( {u}_{1 , ( {s}_{H} , {s}_{V} )}^{o} , {v}_{1 , ( {s}_{H} , {s}_{V} )}^{o} ) {f}_{{r}_{1}}^{*} {g}_{1}^{m} ( {u}_{1 , ( {s}_{H} , {s}_{V} )}^{max} , {v}_{1 , ( {s}_{H} , {s}_{V} )}^{max} ) \\ D ( {u}_{2 , ( {s}_{H} , {s}_{V} )}^{o} , {v}_{2 , ( {s}_{H} , {s}_{V} )}^{o} ) {f}_{{r}_{2}}^{*} {g}_{2}^{m} ( {u}_{2 , ( {s}_{H} , {s}_{V} )}^{max} , {v}_{2 , ( {s}_{H} , {s}_{V} )}^{max} ) \\ ⋮ \\ D ( {u}_{K , ( {s}_{H} , {s}_{V} )}^{o} , {v}_{K , ( {s}_{H} , {s}_{V} )}^{o} ) {f}_{{r}_{K}}^{*} {g}_{K}^{m} ( {u}_{K , ( {s}_{H} , {s}_{V} )}^{max} , {v}_{K , ( {s}_{H} , {s}_{V} )}^{max} )\end{matrix} ]}^{T} ,$$

where gₖ^{m}(uₖ₍ₛ_{_{H}}_{,s}_{_{V}}₎^{max}, v_{k,(s}_{_{H}}_{,s}_{_{V}}₎^{max}) is the maximum angular gain of the (s_{H}, s_{V}) samples of the kth user (assuming it has been scheduled as in Eqn (9)), and (u_{k,(s}_{_{H}}_{,s}_{_{V}}₎^{o}, v_{k,(s}_{_{H}}_{,s}_{_{V}}₎^{o}) is the offset of (uₖ₍ₛ_{_{H}}_{,s}_{_{V}}₎^{max}, v_{k,(s}_{_{H}}_{,s}_{_{V}}₎^{max}) to the center of the (s_{H}, s_{V}) samples, and fᵣ_{ₖ}* is the kth row of F (and taking the conjugate). The diagonal matrix:

D(u_{k,(s}_{_{H}}_{,s}_{_{V}}₎^{o},v_{k,(s}_{_{H}}_{,s}_{_{V}}₎^{o})=diag{1,exp(−j2πu(s_{H}Δw))exp(−j2π(s_{V}Δγ)), . . . ,exp(−j2π(M_{H}−1)(s_{H}Δw))exp(−j2π(M_{V}−1)(s_{V}Δγ))},

rotates the beam from the center of the (s_{H}, s_{V}) samples to the angle with gₖ^{m}(uₖ₍ₛ_{_{H}}_{,s}_{_{V}}₎^{max}, v_{k,(s}_{_{H}}_{,s}_{_{V}}₎^{max}). There are M rows in \check{H}, and hence there needs be M phase shifters for each UE and the K shifted analog signals (total M×K phase shifters) are summed before transmission. This process produces more refined angular beams and, at the same time, reduces leakage of the Fourier Transform.

### ACRONYMS

### 3GPP—Third Generation Partnership Project

### 5G—Fifth Generation

### ADC—Analog-to-Digital Converter

### BS—Base Station

### CN—Complex Normal

### CSI—Channel State Information

eMBB—Enhanced Mobile Broadband

### GBPS—Gigabit per Second

### LNA—Low Noise Amplifier

### LTE—Long Term Evolution

### MIMO—Multiple-In Multiple-Out

### MU-MIMO—Multi-User MIMO

### RF—Radio Frequency

### TDD—Time Division Duplexing

### UE—User Equipment

### ULA—Uniform Linear Array

### UPA—Uniform Planar Array

What we claim is:

1. A method for massive MU-MIMO in wireless communications to quantize the RF signal beams utilizing a UPA at the BS, where
a. for the RF signal beams formed in the uplink, i.e., the UE is the transmitter and the BS is the receiver, the UPA have a response vector,
b. for the RF signal beams formed in the downlink, i.e., the BS is the transmitter and the UE is the receiver, the UPA have a steering vector.

2. A method to quantize the RF signal beams and index them in claim (1) in two-dimensional angular space over the UPA, where
a. the angular space is the dual of the antenna space where the antenna elements forms a UPA,
b. the UPA is characterized by its steering vector or by its response vector,
c. the antenna space can be transformed to the angular space by a Fourier Transform, and vice versa by an Inverse Fourier Transform.

3. A method to quantize the RF signal beams and index them in claim (2) in two-dimensional angular space over the UPA, where
a. using a two-dimensional Fourier Transform to transform the signals transmitted from, or received at, the UPA from the antenna space to the angular space of two-dimensions,
b. dividing the RF signal beams into angular signal paths consisting of the cosines and sines of the elevation and azimuth of each path in the direction of the RF signal impinging upon (as the receiver) or emitting from the UPA (as the transmitter),
c. the elements consisting in the angular signal paths form a channel vector for the UE.

4. A method to quantize the RF signal beams and index them in claim (2) in the two-dimensional angular space over the UPA,
a. using a reference antenna element, e.g., the center element (0,0), of the UPA,
b. using a reference component one-dimensional ULA and another component one-dimensional ULA of the UPA, intersecting at the reference antenna element,
c. using one-dimensional Fourier Transform to transform the signals from the antenna space of the reference component ULAs into the one-dimensional angular space respectively,
d. combining the two separate dimensions to form a composite, two-dimensional angular signal paths of the twos angles of the elevation and azimuth in the direction of the RF signal impinging upon (as the receiver), or emitting from (as the transmitter), the UPA,
e. the composite angular signal paths form a channel vector for the UE, with each element of the channel vector corresponding to an element of the UPA in two dimensions.

5. Constructing the reference component ULAs of claim (4) in the two-dimensional antenna space of the UPA, where
a. the two reference ULAs are orthogonal to each other, or
b. the two reference ULAs are perpendicular, and hence are orthogonal, to each other.

6. Constructing the reference component ULAs of claim (4) in the two-dimensional antenna space of the UPA, where
a. the reference antenna element is at the center of the two reference component ULAs, thus the two reference component ULAs intersect at the center of the UPA, or
b. the reference antenna element is at one of the top-left, bottom-left, top-right, or bottom-right of the UPA, thus the two reference component ULAs intersect at, respectively, the top-left, bottom-left, top-right, or bottom-right of the UPA, or
c. the reference antenna element is, at the middle of an edge of the UPA, i.e., middle left, middle right, top middle, bottom middle of the UPA, thus the two reference component ULAs intersect at, respectively, an middle edge of the UPA.

7. A method to form the channel vector for each available UE transmitting a signal to, or receiving a signal from, the UPA of claim (2), from the channel estimation of that UE,
a. producing the first one-dimensional angular channel vector from the first reference component ULA and producing the second one-dimensional angular channel vector from the second reference component ULA, using one-dimensional Fourier Transform,
b. using the angular cosines and sines of the two angular channel vectors to construct the combined two-dimensional channel vector of the whole UPA for that UE,
c. calculating the complex gain of each element of the two-dimensional channel vector, corresponding to each two-dimensional angular signal path, as a function of the complex gains of the elements of the respective one-dimensional channel vectors,
d. each element of the two-dimensional channel vector, corresponding to the two-dimensional angular signal path, is the gain multiplied by the phases determined by the two-dimensional UPA steering vector (as the transmitter) or response vector (as the receiver).

8. A method to calculate the complex gain of each element of the two-dimensional channel vector, corresponding to each two-dimensional angular signal path of claim (7), where
a. the function is the geometric mean, or the arithmetic mean, or any other function of the projected gains of the elements of the respective one-dimensional channel vectors corresponding to the one-dimensional angular signal paths.

9. A method to produce a composite channel matrix of M elements of the UPA and K UEs that is used for transmitting RF signals from the UPA to the UEs of the massive MU-MIMO system in wireless communications of claim (2), where
a. the K UEs are scheduled from the available UEs that have a two-dimensional channel vector, each two-dimensional channel vector, for example, is obtained through channel estimation,
b. the channel matrix of the M element UPA transmitting to the K UEs, i.e., in the downlink, has K rows of channel vectors of size M.

10. A method to produce a composite channel matrix of M elements of the UPA and K UEs that is used for receiving RF signals at the UPA from the UEs of the massive MU-MIMO system in wireless communications of claim (2), where
a. the channel matrix in the downlink, is the transpose of the that in the uplink, i.e., of the M element UPA receiving from the K UEs, when time-division duplexing is assumed,
b. the channel matrix in the uplink consists of K columns of the transpose of the (row) channel vectors of size M.

11. A schedule method to produce a K×M composite channel matrix in the downlink of claim (9), where
a. the kth UE corresponding to the UE's channel vector from the available UEs is scheduled to transmit,
b. the scheduled UE, based on the total gain of the channel vector, i.e., of its signal paths, results in higher SNR of the received signal, from the BS to the UE,
c. the total gain of the channel vector is defined as the norm of the channel vector,
d. the objective of scheduling UEs is to create a channel matrix that has no more than/non-zero gain elements in each component channel vector of the channel matrix, where/is no greater than a small integer, e.g., 4, such that the non-zero gain values per channel vector results in a simplified matrix inversion solution.

12. A filtering method to produce a K×M composite channel matrix in the downlink of claim (11), where
a. the channel vector of the kth UE contains more than one non-zero gain values,
b. each channel vector element is filtered by its total gain as the ratio of the gain value to the total gain,
c. if the gain of the element is lower than a threshold, the outlier non-zero gain is zeroed so that those corresponding angular signal paths are available to other UEs,
d. the threshold is either an absolute value, or a ratio of the gain to the total gain of the channel vector,
e. the total gain of the channel vector is defined as the norm of the channel vector.

13. A discard method to produce a K×M composite channel matrix for K UEs from the channel vectors of available UEs of claim (12), where
a. the kth UE is discarded from the available UEs, and hence not transmitted, if its total gain falls below a threshold due to resultant poor signal quality,
b. the threshold may be determined as an absolute value, or it may be determined as a ratio to the total gain of the channel matrix,
c. the total gain of the channel matrix is defined as the norm of the full channel matrix.

14. A nulling method to produce a composite channel matrix for K UEs in the downlink, after the filtering of each channel vector from claim (12), where
a. the same angular signal path are non-zero for both UE k and UE i,
b. the signal quality of UE k is much greater than that of UE i, by a threshold,
c. the angular signal path is set to null in the channel vector for UE i,
d. the threshold above may be determined as an absolute value, or it may be determined as a ratio to the total gain of the channel vector.

15. A clustering method to produce a composite channel matrix for K UEs, after the filtering of the channel vector from claim (12), where
a. the channel vector of the kth UE contains n (n<M) non-zero gain values,
b. the channel vector is organized into b (b<K and b<=n) contiguous clusters of non-zero gain values,
c. each contiguous cluster consists of any angular signal path of non-zero gain values that is at least adjacent to another angular signal path in the same cluster,
d. two angular signal paths are adjacent if they are located next to each other in the two-dimensional angular space of the UPA,
e. thus intra-path diversity of all the high gain angular signal paths of a UE are retained, for each cluster, in the channel matrix that results in enhanced signal quality.

16. A splitting method to produce a composite channel matrix for K UEs, after the clustering of the channel vector from claim (15), where
a. the channel vector of the kth UE contains b clusters of angular signal paths of non-zero gain values,
b. the channel vector is split into b independent channel vectors, each of which contains a single cluster,
c. b pseudo-UEs, corresponding to each split (new) channel vector, is added into the set of available UEs, and the size of the set of available UEs is incremented,
d. thus a UE is able to produce more than one pseudo-UEs, which provides inter-path diversity between independently faded signal paths to the same UE, which enhances overall signal quality when the signal paths to the user is poor.

17. A compacting method to produce a composite channel matrix, the channel vector of the kth UE of claim (16) is modified, where
a. the outlier non-zero gains are zeroed until the cluster size is no greater than I, or
b. a cluster is broken up into separate clusters.

18. A fairness method to produce a composite channel matrix for K UEs that are scheduled to transmit from the BS to the UEs, the threshold of the total gain of the channel vector of claim (17) is dynamically adjusted, where
a. the diversity of the signal path to one or more specific UEs is reduced by nulling adjacent channel vector elements,
b. the diversity of the signal path to one or more specific UEs is increased by scaling gain of the channel vector element so that signal quality is improved to trade off for fairness between different UEs.

19. A prioritization method to produce a composite channel matrix for K UEs that are scheduled to transmit from the BS to the UEs, from the cannel vectors of the available UEs of claim (11),
a. the kth UE from the available UEs is scheduled to transmit with a higher priority because its resultant total gain is higher than the mth user,
b. all UEs are prioritized in decreasing total gain, and the total gain of a UE is the norm of the channel vector,
c. the (K+1)th UE is not transmitted if a total number of K users have been scheduled with higher priority.
